(19) United States
(12) Patent Application Publication
(10) Pub. No.: US 2011/0018698 A1
(43) Pub. Date: Jan. 27, 2011

(54) Electrical car sensor for blind spots

(76) Inventor: Charlton Rodriguez, Aventura, FL (US)

Correspondence Address: Charlton Rodriguez, 18011 Biscayne Bulevard Apartment #1102, 1 South, Aventura, FL, 33160, US

(21) Appl. No.: 12/455,190

(22) Filed: Jul. 27, 2009

(51) Int. Cl. B60Q 1/00

(52) U.S. Cl. 340/435

(57) ABSTRACT

The purpose of this invention of the electrical metal sensor of the automobile is to detect vehicles in motion and their blind spot of both sides of the car so that the driver will have enough time to react to or prevent a car accident. As the engine of the car is running, the electrical metal sensor will be activated. Vehicles to the blind spot of the car will be detected while they are stable or at motion. The screen monitor is going to be plugged into the cigarette lighter and wires or cables of the sensor of the automobile will be connected to the brain computer in the car.

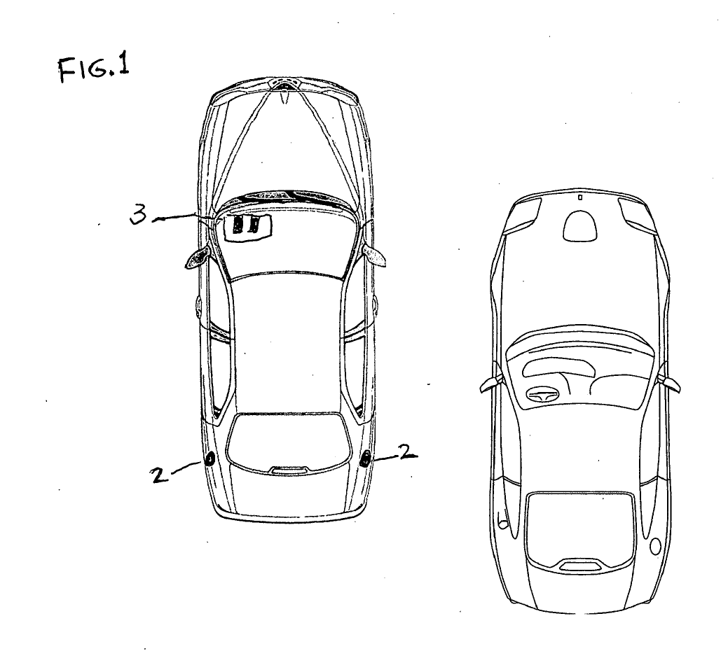

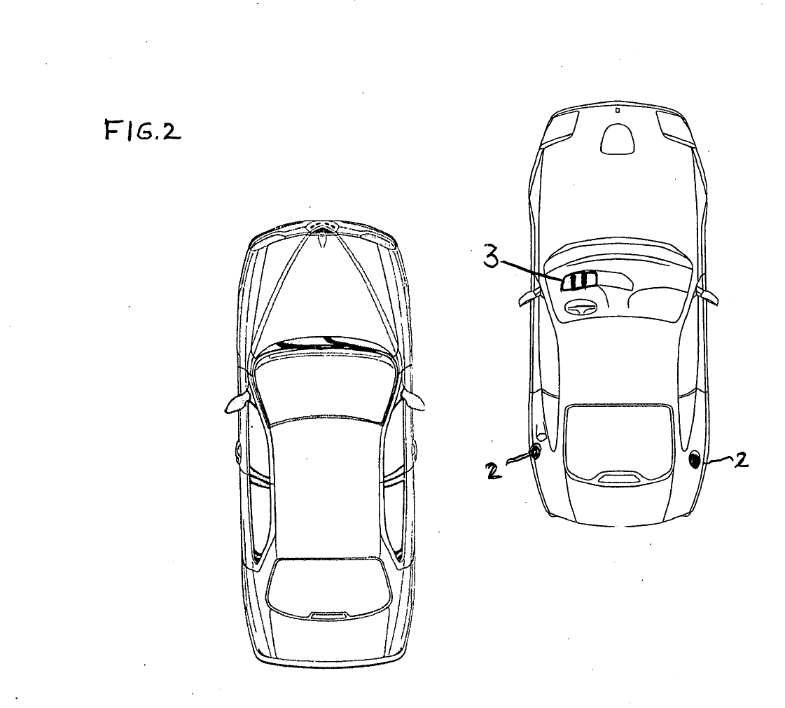

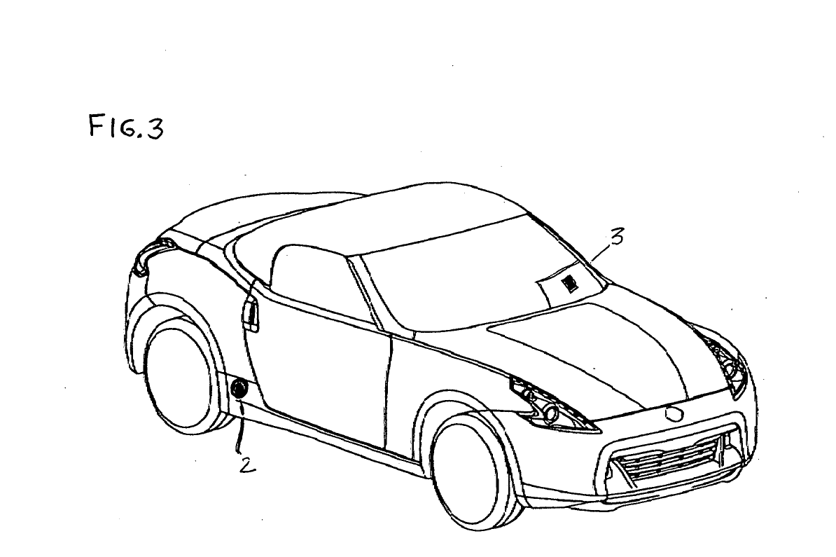

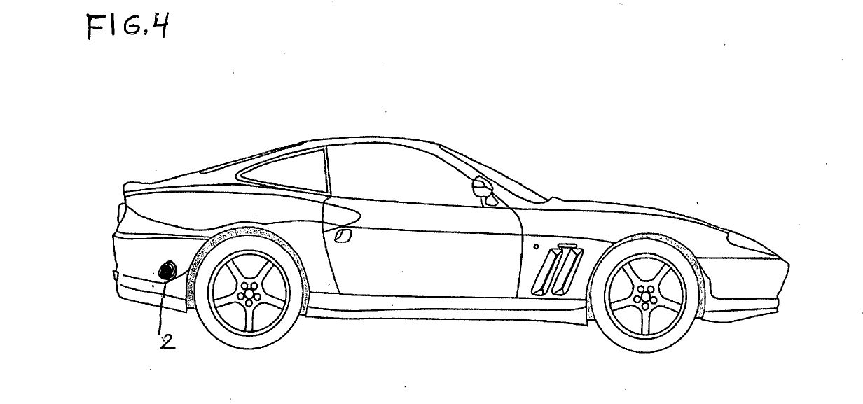

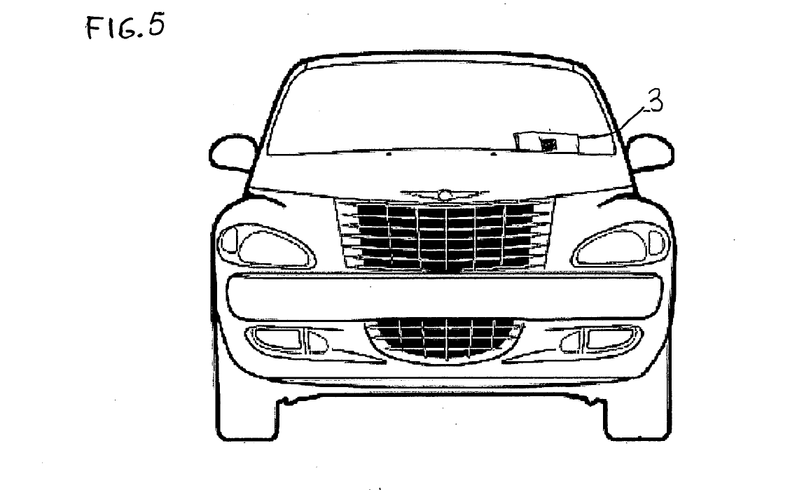

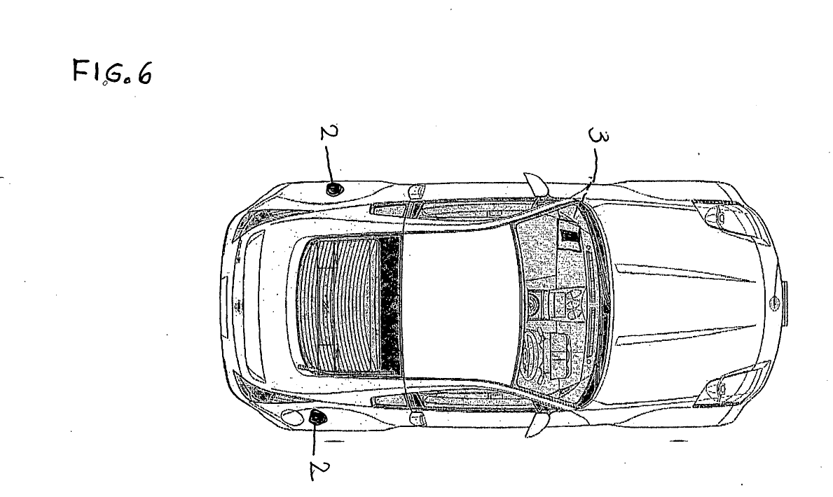

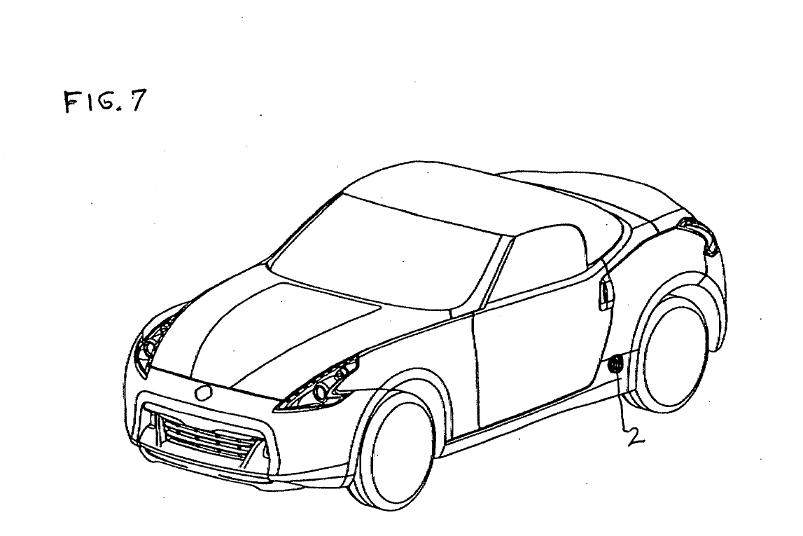

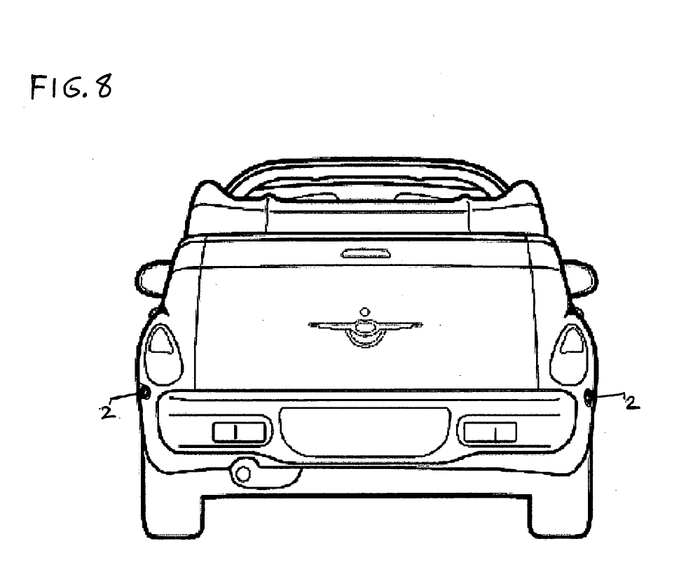

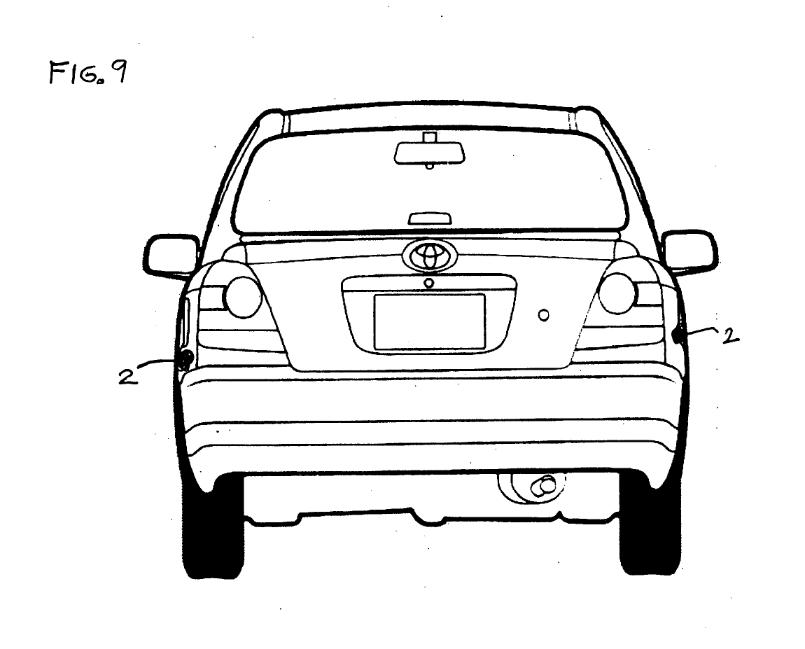

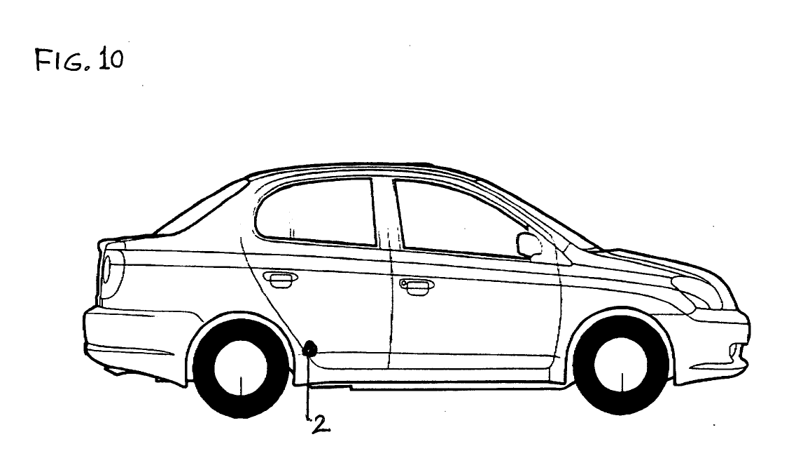

The Electrical Car Sensors are focused on the Blind Spot. The Electrical Sensor is designed to detect vehicles or objects that are at movement or that may be static with the motor engine running. The sensors would be installed on all exterior parts of the car (right, left, and rear). The purpose of this invention is to reduce death rates caused by car accidents. The sensors are meant to be installed onto normal sized cars; however, the sensors would be adaptable to any other size of a vehicle to locate cars in the blind spot. Cables and wires could be utilized to activate the vehicle's sensors. On the inside of the vehicle, a screen monitor would be connected to the exterior sensors, allowing for the driver to acknowledge any other vehicle in the blind spot and the position of the vehicle at all times. The sensors and screen monitor will function only while the car engine is running. Some advantages the vehicles will benefit from are: a blocking control system that detains the driver from turning to another car that is in the blind spot, a self-activated light that will flash to serve as an alert, and an optional and adjustable sound device that would prevent or awaken the driver in the case of the driver falling asleep. The sound device would identify that there is a car in the driver's blind spot. Other benefits that could apply are: the sensors would be stimulated in the rear part of the car to detect if there's anyone nearby by sensing body heat (The body heat would be that of any pedestrian, pet, etc.), and sensors with a capacity to distinguish people nearby or from a distance of up to 4 meters from the sensor. With this invention, people will have more availability to the sensors and this system will be installed into cars to prevent accidents and allow people to be aware of their surroundings and cars in their blind spot. Humanity will be supported and maintain safe procedures.

### DRAWING GUIDELINE OF THE BLIND SPOT SENSOR CAR

2) Electrical Blind Spot Sensors (Right, left, and rear of the car)
3) Indoor Screen Monitor
4) Front side of the car
5) Rear side of the car
6) Right side of the car
7) Left side of the Car
8) Permitted side to turn
9) Restricted side of the car where the sensors won't allow turning

1. The electrical sensor system of the car for blind spot functions the following way: two electrical sensors are located to the right and the left sides of the rear part of the automobile behind a metal. The sensors are going to be installed in the automobile with wires connected to the brain computer and the body of the car. These sensors will detect metals or other automobiles located in the blind spot of the car, this could be to the right or the left side panorama. The sensor system will be incorporated and programmed to the brain computer. The programmed range of the distance the sensor will detect will be at maximum four meters wide and as close as one foot from the blind spot. Once the electrical metal sensor is activated around all the sides of the automobile, the perspective of the car in motion will be seen in the panel of the blind spot. The screen monitor panel will be adapted and plugged in the cigarette lighter connection of the vehicle. The screen monitor panel may be connected or disconnected as an option of the driver. The electrical sensor will begin to function once the engine is running. The sensor will detect vehicles permanently from the blind spot at all times even if the vehicles are stable or in motion. The sensor will send a light signal to the screen monitor panel that will be in the front part of the car located in front of the driver. This allows the passenger and driver to be aware of the blind spot and of its surroundings.
